(19) United States
(12) Patent Application Publication
(10) Pub. No.: US 2025/0073614 A1
(43) Pub. Date: Mar. 6, 2025

(54) OIL-WATER SEPARATION FILTER AND APPARATUS, AND METHOD OF OPERATING THE SAME

(71) Applicant: VULCAN PHOTONICS SDN. BHD., Kuala Lumpur (MY)

(72) Inventors: Khong Nee Koo, Ayer Itam, Pulau Pinang (MY); Mei Qun Seah, Subang Jaya, Selangor (MY); Farah Hidayah Binti Jamaludin, Johor Bahru, Johor (MY)

(21) Appl. No.: 18/271,709

(22) PCT Filed: Sep. 28, 2022
(86) PCT No.: PCT/IB2022/059209

§ 371 Date: Jul. 11, 2023

(30) Foreign Application Priority Data
Jul. 5, 2022 (SG) 10202250370U

(51) Int. Cl. B01D 17/04; B01D 39/10; C02F 1/40; C02F 101/32

(52) U.S. Cl. CPC B01D 17/045; B01D 39/10; C02F 1/40; B01D 2239/0421; B01D 2239/0478; B01D 2239/10; C02F 2101/32

(57) ABSTRACT

Described herein is a filter comprising a mesh and a coating layer on the mesh, the coating layer having a first silane moiety and a pH-responsive polymer. The first silane moiety includes a hydrophobic alkyl chain. The first silane moiety is attached directly to the mesh and the pH-responsive polymer is attached to the mesh by a linker. The mesh may be switched between being hydrophilic and oleophilic by acid or alkaline treatment, or temperature treatment. Also described is a method to prepare the filter, a connector having the filter, an apparatus having the connector, and a method of separating an oil-water mixture.

### RELATED APPLICATIONS

The present application claims priority to and the benefit of Singapore patent application Ser. No. 10/202,250370U, filed 5 Jul. 2022, which is hereby incorporated by reference in its entirety.

### TECHNICAL FIELD

Various embodiments relate to an oil-water separation filter, a connector, an apparatus containing the oil-water separation filter, and a method for preparing the oil-water separation filter and operating the connector and apparatus.

### BACKGROUND

Oily wastewater is commonly produced in every major step of the lifetime of petroleum: exploration, transportation, storage, refining, application, and disposal. The oily wastewater and also an oil spill demands timely actions to separate oil from water. Thus, the petroleum industry, environmental protection agencies, and even non-governmental organizations (NGOs) have been investing heavily in technologies that can efficiently and effectively separate an oil-water mixture. Depending on the amount of oil present and the timing of response, the traditional oil treatment technologies include physical collection by skimmer and pumping, physical confinement by a floating boom, air flotation, gravity separation, etc. However, each of these technologies has its niche application scenario, out of which it becomes ineffective, and increases costs as different solutions must be prepared for the different scenarios.

To suit an enlarged scope of applications, wettability-based filtration approaches for oil-water separation have been developed. Based on the different wetting behaviors of oil and water, the mixture of oil and water can be effectively separated by porous materials with either hydrophobicity/superhydrophobicity or underwater oleophobicity/superoleophobicity wettability. Oil-water separation materials with non-responsive and pre-fixed wettability have been developed, but lack the flexibility of offering opposite separation by the same material, and is impossible to recover the oil phase and reuse the separation material. Wettability switchable of oil-water separation technologies that offer oil recovery and recycling of separation materials have been highly sought in the past decade, and contribute to a sustainable solution to the long-standing oil-water separation problems.

### SUMMARY OF INVENTION

Various embodiments provide a filter. The filter includes a mesh and a coating layer on the mesh. The coating layer includes a first silane moiety and a pH-responsive polymer. The first silane moiety includes a hydrophobic alkyl chain. The first silane moiety is attached directly to the mesh, and the pH-responsive polymer is attached to the mesh by a linker.

Various embodiments further provide a method of preparing a filter. The method includes a step of modifying a surface of a mesh with a mixture to provide a modified surface of the mesh. The mixture includes a first silane moiety and a linker, and the first silane moiety includes a hydrophobic alkyl group and at least one alkoxy group. The method also includes a step of reacting a pH-responsive polymer with the linker on the modified surface to form a coating layer on the mesh. The surface of the mesh reacts with the reagents in the mixture to provide a modified surface of the mesh, for example this may be by silanization.

Various embodiments further provide a filter prepared by the aforementioned method.

Various embodiments yet further provide a connector separation of oil and water. The connector includes an inlet for receiving an inflow of an oil-water mixture, an oil outlet for dispensing an outflow of oil, and the first filter as mentioned above or prepared by the method mentioned above, a water outlet for dispensing an outflow of water, and the second filter as mentioned above or prepared by the method as mentioned above. The first filter is arranged proximate to the oil outlet and treated to repel water and allow oil to flow through the first filter to provide the outflow of oil. The first filter may be alkaline-treated or temperature treated to have the oleophilic property. The second filter is arranged proximate to the water outlet and treated to repel oil and allow water to flow through the second filter to provide the outflow of water. The second filter may be acid-treated or temperature treated to have the hydrophilic property. The temperatures at which the mesh and hence filter switch between hydrophilic and oleophilic depends on the specific polymer, but generally the temperature at which the mesh becomes hydrophilic is lower than the temperature at which the mesh becomes oleophilic. The pH and temperature at which the mesh and hence filter becomes hydrophilic and oleophilic may be known as threshold values, thus the mesh may become hydrophilic at a first pH threshold value and/or a first temperature threshold value, and becomes oleophilic at a second pH threshold value and/or a second temperature threshold value. The first filter is at least partially arranged at a higher elevation relative to the second filter to increase likelihood of contact of the oil of the oil-water mixture with the first filter when the oil-water mixture flows from the inlet to the oil outlet and the water outlet by the action of gravity.

Various embodiments yet further provide an oil-water separation apparatus. The apparatus includes a feed tank for holding an oil-water mixture, an oil tank for holding oil, a water tank for holding water, and the connector as mentioned above. The inlet is fluidly coupled to the feed tank, the oil outlet is fluidly coupled to the oil tank, and the water outlet is fluidly coupled to the water tank.

Various embodiments yet further provide a method of separating an oil-water mixture. The method includes feeding the oil-water mixture into the connector as above mentioned via the inlet of the connector, contacting the first filter and the second filter of the connector with the oil-water mixture, passing oil through the first filter and out of the connector via the oil outlet, and passing water through the second filter and out of the connector via the water outlet.

### BRIEF DESCRIPTION OF DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1 shows a perspective view of an exemplary oil-water separation apparatus, according to various embodiments.

FIGS. 2(a) to 2(c) show schematics illustrating a top, front, and side view, respectively, of the exemplary oil-water separation apparatus, according to various embodiments.

FIG. 3 shows a perspective view of an exemplary connector, according to various embodiments.

FIG. 4(a) shows a scanning electron microscope (SEM) image of the original surface of a sintered stainless steel mesh. FIG. 4(b) shows an SEM image of the functionalized surface of a sintered stainless steel mesh.

FIG. 5(a) shows an image of the water contact angle on the surface of the functionalized mesh in the air. FIGS. 5(b) and 5(c) show still images captured from video measurements of an acidic water droplet on the functionalized mesh in the air. FIG. 5(d) shows an image of the underwater oil contact angle on the surface of the functionalized mesh in acidic water. FIGS. 5(e) and 5(f) show still images captured from video measurements of an oil droplet on the functionalized mesh in the air.

### DETAILED DESCRIPTION

The following detailed description refers to the accompanying drawings that show, by way of illustrations, specific details, and embodiments in which the invention may be practiced. These embodiments are described in sufficient detail to enable those skilled in the art to practice the invention. Other embodiments may be utilized and changes may be made without departing from the scope of the invention. The various embodiments are not necessarily mutually exclusive, as some embodiments can be combined with one or more embodiments to form new embodiments.

Embodiments described in the context of one of the methods, filter, or connector are analogously valid for the other methods, filter, or connector. Similarly, embodiments described in the context of a method are analogously valid for an apparatus, and vice versa.

Features that are described in the context of an embodiment may correspondingly be applicable to the same or similar features in the other embodiments. Features that are described in the context of an embodiment may correspondingly be applicable to the other embodiments, even if not explicitly described in other embodiments. Furthermore, additions and/or combinations and/or alternatives described for a feature in the context of an embodiment may correspondingly be applicable to the same or similar feature in the other embodiments.

In the context of various embodiments, the articles “a”, “an”, and “the” as used with regard to a feature or element include a reference to one or more of the features or elements.

In the context of various embodiments, the terms “cross-linking agent”, “cross-linker”, and “linker” are interchangeable. The term “cross-linking” is to be interpreted broadly to refer to forming covalent bonds or crosslinks between a molecule and a polymer and/or between polymers.

Ranges may be disclosed herein and it should be understood that the description in range format is merely for convenience and brevity and should not be construed as an inflexible limitation on the scope of the disclosed range. Accordingly, the description of a range should be considered to have specifically disclosed all the possible sub-ranges as well as individual numerical values within that range. For example, a description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, 1, 2, 3, 4, 5, and 6. This applies regardless of the breadth of the range.

The term “alkyl” used alone or as part of a larger moiety, such as alkoxy, haloalkyl, arylalkyl, alkylamine, cycloalkyl, dialkylamino, alkylamino, dialkylamino, alkylcarbonyl, alkoxycarbonyl and the like, includes as used herein means saturated straight-chain, cyclic or branched aliphatic group.

The terms “amine” and “amino” are used interchangeably and shall mean —NH₂, —NHR, or —N(R)₂, wherein R is alkyl and/or aryl. The term “alkoxy” means —O-alkyl or —O-aryl.

Although the terms first and second may be used herein to describe various silane moieties, filters, angles, and/or elements, these silane moieties, filters, angles, and/or elements should not be limited by these terms. These terms may be only used to distinguish one silane moiety, filter, angle, and element from another silane moiety, filter, angle, and element. Terms such as “first”, “second”, and other numerical terms when used herein do not imply a sequence or order unless indicated by the context. Thus, a first moiety or element discussed below could be termed a second moiety or element without departing from the teachings of the example embodiments.

Various embodiments may provide a filter that may efficiently and effectively separate an oil phase from a water phase in a mixture thereof by passing the oil phase and the water phase through an oleophilic/superoleophilic filter and a hydrophilic/superhydrophilic filter, respectively. In particular, embodiments of the invention may provide for a filter that includes a mesh and a coating layer on the mesh. The coating layer includes a first silane moiety and a pH-responsive polymer, wherein the first silane moiety includes a hydrophobic alkyl chain. The first silane moiety is attached directly to the mesh and the pH-responsive polymer is attached to the mesh by a linker. The linker may be any suitable functional group for the monomer and polymer. For example, if the pH-responsive polymer is a cationic polymer, the filter may advantageously switch its surface wettability from oleophilic/superoleophilic to hydrophilic/superhydrophilic by altering the pH from an alkaline range to an acidic range, and vice versa. Advantageously, the switchability may be purely water-based and highly controllable by adjusting the pH of the water, making the filter environmentally friendly and low cost. The hydrophobic alkyl chain of the first silane moiety provides the oleophilic characteristic of the filter, while the pH-responsive polymer provides the hydrophilic characteristics of the filter. When the filter is acid treated, the cationic polymer is protonated and exhibits an extended conformation because of the electrostatic repulsion among the like charges. Hence, the protonated polymers tend to stretch and cover the surface of the mesh making it hydrophilic in nature possibly by the formation of one or more hydrophilic layers on the mesh surface. The hydrophilic layer may effectively cover the hydrophobic alkyl chain of the first silane moiety, which endows the filter with superior oil-repellence ability after acid treatment. When the filter is alkaline treated, the cationic polymer is not protonated and may exhibit a collapsed conformation which may allow the hydrophobic alkyl chain of the first silane moiety to dominantly expose themselves and turn the surface of the mesh oleophilic (and hydrophobic). The alkaline treated filter thus has a high affinity to oil. The pH values where the filter becomes hydrophilic and oleophilic may be termed pH threshold values, where the pH threshold value for conversion to being hydrophilic is lower than the pH threshold value for conversion to being oleophilic. Alternatively, the filters may be switched between the hydrophilic and oleophilic nature by the temperature. The temperatures where the filter becomes hydrophilic and oleophilic may be termed temperature threshold values The temperature at which the filter becomes hydrophilic is generally lower than the temperature at which the filter becomes oleophilic. Thus, the mesh and filter switch between being oleophilic and hydrophilic by changes in the pH of a solution contacting the mesh and/or by temperature.

The terms “acid treated or acid treatment” and “alkaline treated or alkaline treatment” refer to the general trend of a low pH and a high pH solution contacting the filter for a sufficient amount of time to convert the surface wettability of the mesh and filter. The exact pH where the polymer changes its hydrophilic character to oleophilic character and vice versa will depend on the pKa of the polymer in question and may be determined by measurement methods available in the art, or by determining the separation efficiency of the filter. It will be appreciated that pH is dependent on the solvent and temperature. Herein, the pH refers to an aqueous solution at a temperature of 25° C.

The term “temperature treated or temperature treatment” refers to subjecting the mesh to a temperature to allow the mesh to convert to its oleophilic or hydrophilic nature. The temperatures at which the polymer converts between the oleophilic and hydrophilic nature depend on the specific polymer structure.

Various embodiments may also provide a method of preparing the aforementioned filter, which may efficiently manufacture the filter under easily available reaction conditions. In particular, the embodiments may provide for a method of preparing a filter that includes modifying a surface of a mesh with a mixture to provide a modified surface of the mesh, wherein the mixture includes a first saline moiety and a linker, wherein the first saline moiety includes a hydrophobic alkyl group, and reacting a pH-responsive polymer with the linker on the modified surface to form a coating layer on the mesh. Advantageously, the method may be used to prepare the filter without using large amounts of chemical reagents and yet requiring fewer steps.

Various embodiments may further provide a connector that has the aforementioned filters employed, which may efficiently separate the oil and water in continuous phases simultaneously and continuously. In particular, the embodiments may provide for a connector that includes an inlet for receiving an inflow of an oil-water mixture, an oil outlet for dispensing an outflow of oil, a first filter as above-mentioned, or a first filer prepared by the above-mentioned method, the first filter arranged proximate to the oil outlet and treated to repel water and allow oil to flow through the first filter to provide the outflow of oil, a water outlet for dispensing an outflow of water, a second filter as above-mentioned, or a second filer prepared by the above-mentioned method, the second filter arranged proximate to the water outlet and treated to repel oil and allow water to flow through the second filter to provide the outflow of water. The first filter is at least partially arranged at a higher elevation relative to the second filter to increase the likelihood of contact of the oil of the oil-water mixture with the first filter when the oil-water mixture flows from the inlet to the oil outlet and the water outlet by the action of gravity. For the filters, if the pH-responsive polymer is a cationic polymer the first filter is alkaline treated, and the second filter is acid treated. Alternatively or in combination, the first and second filters may also be temperature treated to obtain the necessary characteristic. For example, when the polymer is PDMAEMA, the first filter may be alkaline treated at a pH of 8 and higher and/or heated to a temperature of at least 55° C. to allow the filter to have the oleophilic property. The filter changes from oleophilic to hydrophilic at a pH of 2 and lower and/or at a temperature of 25° C. and lower. This configuration is applicable for an oil-water mixture where water is denser than the oil, if the oil is denser the oil-water mixture may still be separated by a few modifications including switching the filters either physically or by switching their wettability characteristic, or adding a second oil with lower density to make an oil solution that has an overall density lower than water. Advantageously, the connector along with the filers may possess excellent utility energy saving due to gravity separation of the oil-water mixture.

Various embodiments may yet further provide an oil-water separation apparatus that has the aforementioned connector employed that may efficiently separate the oil and water. In particular, the embodiments may provide an oil-water separation apparatus that includes a feed tank for holding an oil-water mixture; an oil tank for holding (or receiving) oil from the connector; a water tank for holding (or receiving) water from the connector; and the connector as described above. The inlet is fluidly coupled to the feed tank, the oil outlet is fluidly coupled to the oil tank, and the water outlet is fluidly coupled to the water tank. Pumps may be used to feed the oil-water mixture into the inlet or the feed tank placed above the inlet depending on the setup of the apparatus. Advantageously, the oil and water may be efficiently separated by the apparatus under gravity. The filters utilized in the connector and apparatus may be used multiple times and for an extended period without degradation or loss of the filtration efficiency.

Various embodiments may provide a method of operating the connector to efficiently separate oil and water in a mixture thereof. In particular, embodiments of the invention may provide for a method of operating such an apparatus that includes feeding the oil-water mixture into the aforementioned connector via the inlet of the connector, contacting the first filter and the second filter of the connector with the oil-water mixture, passing oil through the first filter and out of the connector via the oil outlet, and passing water through the second filter and out of the connector via the water outlet. Advantageously, the method may be simply conducted with gravity achieving an efficient separation rate.

In view of the above, compared to previous oil-water separation technologies, the embodiments may provide a simple solution for an effective oil-water separation without using large amounts of chemical reagents and yet possessing excellent utility energy saving due to gravity separation, thus offering a very low capital and operating cost.

The embodiments described are generally resistant to corrosion and may require little or no pre-treatment to the oil-water mixture prior to the separation process. The coating layer may also be coated on a different substrate and integrated with different module sizes (for example the size of the mesh and/or connector) based on demand, and thus may offer very good space saving with excellent oil-water separation efficiency. The unique on-demand oil wettability switchable behavior of the filter may allow for easy oil removal from complex and various matrices and easy oil recovery, which may otherwise be impossible practically or cost-prohibitive with conventional oil removal adsorbent/materials. Additionally, the oil wettability may be water-based and highly controllable making it environmentally friendly and low cost.

### Oil-Water Separation Filters

In various embodiments, a filter includes a mesh and a coating layer on the mesh. The coating layer includes a first silane moiety and a pH-responsive polymer, the silane moiety includes a hydrophobic alkyl chain, and the first silane moiety is attached directly to the mesh, and the pH responsive polymer is attached to the mesh by a linker.

In various embodiments, the pH-responsive polymer may be a cationic polymer that is protonated under acidic conditions. In various embodiments, the cationic polymer may be a homopolymer of general formula (I),

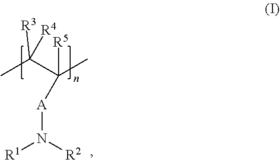

wherein R¹ and R² may each be independently selected from methyl, ethyl, propyl, and isopropyl, R³, R⁴, and R⁵ may each be independently selected from hydrogen, methyl, and ethyl, and A may be a linking group selected from the group consisting of an ester, an amide, an ether, a methylene chain, and any combinations thereof. The pH-responsive polymer is attached to the linker by bonding to at least one amino group in the pH-responsive polymer. Thus, the polymer may be attached to the mesh via the bonding of the linker to at least one amino group in the side chain of the polymer. Some of the amino groups in the polymer side chain will be bonded to the linker to attach the polymer to the mesh via the linker, while the other unbonded amino groups are available to be protonated to function as a pH-responsive polymer.

In various embodiments, A has a general formula (II),

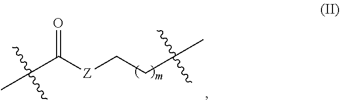

wherein Z may be oxygen or NR⁶, R⁶ may be hydrogen, methyl, or ethyl, and m may be 1, 2, 3, or 4. Preferably, the carbon of the carbonyl group is attached to the polymer backbone.

In various embodiments, Z may be oxygen and m may be 1. Preferably, the ester carbonyl is attached to the polymer backbone in formula (I).

In various embodiments, R¹ and R² may be methyl when Z may be oxygen and m may be 1. Preferably, the ester carbonyl is attached to the polymer backbone in formula (I).

In one example, R¹ and R² are methyls, and the pH-responsive polymer is attached to the linker by quaternization of at least one amino group in the pH-responsive polymer. For example, where R¹ and/or R² are not methyl, the amino group may react with one or more of the linker moieties. The amino group may react with the appropriate number of linker moieties to form a quaternary ammonium salt.

In various embodiments, R³ and R⁴ may be hydrogen, and R⁵ may be methyl. Preferably, Z may be oxygen and m may be 1. In an example, the pH-responsive polymer is poly(2-(N,N-dimethylamino)ethyl methacrylate) (PDMAEMA) whose structure is shown below. Preferably, the number average molecular weight (Mₙ) of poly(2-(N,N-dimethylamino)ethyl methacrylate) is 10,000 g/mol. A Mₙ significantly larger than 10,000 g/mol may have an adverse effect on the superhydrophilicity at low pH due to a longer polymer chain and affects the switchable surface wettability of the filter.

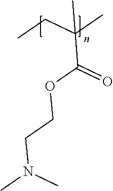

poly(2-(N,N-dimethylamino)ethyl methacrylate)(PDMAEMA)

In various embodiments, the hydrophobic alkyl chain of the first silane moiety may have at least 13 carbon atoms, preferably at least 15 carbon atoms, more preferably at least 16 carbon atoms. In an example, the hydrophobic alkyl chain may have 16 to 20 carbon atoms. The number of carbon atoms refers to that in the longest alkyl chain itself and the number excludes any substituents. It will be appreciated that the hydrophobic alkyl chain may be substituted or unsubstituted, saturated or unsaturated, without losing its hydrophobic character.

In various embodiments, the linker as above-mentioned includes a second silane moiety having an alkyl group and an alkoxy group.

In various embodiments, the alkyl group of the second silane moiety may have 2 to 6 carbon atoms, preferably 2 to 4 carbon atoms. Advantageously, short alkyl chains will be preferred in the linker to avoid conferring any unrequired hydrophobic character to the mesh.

In one example, the first silane moiety and/or second silane moiety are each independently attached to the mesh by 1 to 3 silicon-oxygen bonds, preferably 2 silicon-oxygen bonds, more preferably 3 silicon-oxygen bonds. The silane used for functionalizing the mesh typically contains 1 to 3 alkoxy groups of which part or all may be displaced by hydroxyl groups on the mesh surface to form the silicon-oxygen bond. Thus, the number of silicon-oxygen bonds formed typically depends on the reagent used to functionalize the mesh. In addition, the first silane moiety may have two or three hydrophobic alkyl chains and thus have fewer alkoxy groups. Similarly, the second silane moiety may have two or three alkyl groups. While most of the alkoxy groups in the silane moieties may be displaced by the hydroxyl groups on the mesh surface, some of the alkoxy groups may remain in the coating layer.

In various embodiments, a molar ratio of the first silane moiety to the linker is from 1:4 to 2:1, preferably 1:3 to 1.8:1, more preferably 1:1 to 1.8:1. In various embodiments, a molar ratio of the first silane moiety to the pH-responsive polymer is from 1:4 to 2:1, preferably 1:3 to 1.8:1, more preferably 1:1 to 1.8:1. Advantageously, the molar ratio as described allows the filter to possess switchable hydrophilic and oleophilic characteristics.

In various embodiments, the mesh may be made of metal, and may preferably be stainless steel or aluminum. In one example, the mesh is more preferably made of sintered stainless steel. Sintered stainless steel mesh is preferred over other materials as it possesses the following characteristics: a uniform pore size distribution, a high holding capacity due to its multi-layer structure, easy to clean and back flush in situ, high temperature resistance, high corrosion resistance, strong acid and alkaline resistance, strong organic solvent resistance, and a high degree of mechanical flexibility. The filter may further advantageously possess a long service life due to a combination or all of the characteristics.

The mesh may be treated in an acidic solution, or treated in an alkaline solution. Alternatively, the mesh may be temperature treated. The mesh may be made hydrophilic by treatment at a first pH threshold value and lower and/or at a first temperature threshold value and lower. The mesh may be made oleophilic by treatment at a second pH threshold value and higher and/or at a second temperature threshold value and higher. For a polymer of general formula (I), the first pH threshold value and the first temperature threshold value are lower than the second pH threshold value and the second temperature threshold value respectively.

In an example where the polymer is PDMAEMA, the mesh may be treated at a pH of 2 and lower in the acid treatment or at a pH of 8 and higher in the alkaline treatment. Thus, the first and second pH threshold values are 2 and 8 respectively. Alternatively or in combination, the mesh may be converted to being oleophilic by heating at a temperature of at least 55° C. and may be converted to hydrophilic at a temperature of 25° C. and lower. Thus, the first and second temperature threshold values are 25° C. and 55° C. respectively.

### Methods for Preparing the Oil-Water Separation Filters

In various embodiments, a method of preparing a filter, the method includes a step of modifying a surface of a mesh with a mixture to provide a modified surface of the mesh. The mixture may include a first silane moiety and a linker, the first silane moiety having a hydrophobic alkyl group and at least one alkoxy group. The method of preparing the filter further includes a step of reacting a pH-responsive polymer with the linker on the modified surface to form a coating layer on the mesh.

In various embodiments, the pH-responsive polymer may be a homopolymer of general formula (I),

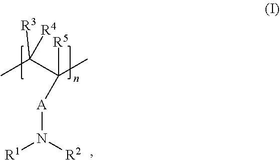

wherein R¹ and R² may each be independently selected from methyl, ethyl, propyl, and isopropyl, wherein R³, R⁴, and R⁵ may each be independently selected from hydrogen, methyl, and ethyl, and wherein A may be a linking group selected from the group consisting of an ester, an amide, an ether, a methylene chain, and any combinations thereof.

In various embodiments, A as above-mentioned may be of formula (II)

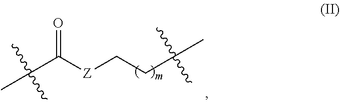

wherein Z is oxygen or NR⁶, R⁶ is hydrogen, methyl, or ethyl, and wherein m is 1, 2, 3, or 4. Preferably, the carbon of the carbonyl group is attached to the polymer backbone.

In various embodiments, Z may be oxygen and m may be 1.

In various embodiments, the pH-responsive polymer may fulfill at least one of the following conditions:
(i) R¹ and R² are methyls;
(ii) R³ and R⁴ are hydrogen and R⁵ is methyl;
(iii) the hydrophobic alkyl chain of the first silane moiety have at least 13 carbon atoms;
(iv) the linker comprises a second silane moiety having an alkyl group with a leaving group to be substituted with the pH responsive polymer and an alkoxy group; and
(v) the mesh is made of metal, preferably stainless steel or aluminum, more preferably sintered stainless steel.

In various embodiments, the alkyl group of the second silane moiety may have 2 to 6 carbon atoms, preferably 2 to 4 carbon atoms. In various embodiments, the first silane moiety and/or second silane moiety may have three alkoxy groups. As an example, the second silane moiety may have a general formula of Si(OR⁷)ₚ(R⁸-LG)_{q}, where R⁷ is an alkyl group, R⁸ is a methylene chain, LG is a leaving group, p and q are selected from 1 to 3, where a total of p and q is 4. Non-limiting examples of a leaving group include triflate, mesylate, tosylate, iodo, bromo, and chloro. OR⁷ is an example of an alkoxy group.

In one example, the pH-responsive polymer may be poly(2-(N,N-dimethylamino)ethyl methacrylate). Preferably, the number average molecular weight of poly(2-(N,N-dimethylamino)ethyl methacrylate) may be 10,000 g/mol.

In various embodiments, a molar ratio of the first silane moiety to the linker is from 1:4 to 2:1, preferably 1:3 to 1.8:1, more preferably 1:1 to 1.8:1. In various embodiments, a molar ratio of the first silane moiety to the pH-responsive polymer is from 1:4 to 2:1, preferably 1:3 to 1.8:1, more preferably 1:1 to 1.8:1.

In various embodiments, the method may also include treating the coated mesh with an acidic solution. This may be done by contacting, washing or soaking the coated mesh in an acidic solution with the required pH at or below the first pH threshold value, for example hydrochloric acid. Alternatively, the method may also include treating the coated mesh with an alkaline solution. This may be done by contacting, washing or soaking the coated mesh in an alkaline solution with the required pH at or above the second pH threshold value, for example a solution of sodium carbonate or sodium hydroxide. Any other suitable buffers, acids, or bases may be used in the acid and alkaline treatment. Alternatively, the coated mesh may be temperature treated to have the desired hydrophilic or oleophilic characteristic. The coated mesh may be converted to being hydrophilic at a first temperature threshold value and oleophilic at a second temperature threshold value, the first temperature threshold value being lower than the second temperature for a polymer of general formula (I). In an example where the polymer is PDMAEMA, the mesh may be converted to hydrophilic by treating the mesh with an acidic solution of a pH of 2 and less, or by temperature treatment (keeping or storing) of the mesh at a temperature of 25° C. and less. The mesh may be converted to oleophilic by treating the mesh with an alkaline solution of a pH of 8 and more, or by temperature treatment (heating) of the mesh at a temperature of 55° C. and more.

In various embodiments, the coated mesh may be treated with an acidic solution of a first pH threshold value and lower and/or keeping the coated mesh at a first temperature threshold value and lower to make the coated mesh hydrophilic, preferably at a pH of 2 and lower and/or keeping the coated mesh at 25° C. and lower. In various embodiments, the coated mesh may be treated with an alkaline solution of a second pH threshold value and higher and/or heating the coated mesh at a second temperature threshold value and higher to make the coated mesh oleophilic, preferably at a pH of 8 or higher and/or heating the coated mesh at 55° C. and higher.

### Oil-Water Separation Filter Example

In an example, a sintered stainless steel mesh is added to 200 mL of a toluene solution containing about 2 g of (3-Iodopropyl) trimethoxysilane (IPS) and trimethoxy (octadecyl) silane (OTS) to functionalize the surface with iodo functional groups (from IPS) and hydrophobic alkyl groups (from OTS) via silanization. The mass ratio of IPS to OTS used is 3:7, which is equivalent to a molar ratio of about 1:1.8. After continuous and vigorous stirring for about 12 hours at room temperature, the silanized mesh is rinsed with toluene and ethanol to remove the unreacted siloxane, followed by drying in an oven for 1 hour at about 60° C. The dried silanized meshes may then be added to 1 wt. % ethanol solution of poly(2-(N,N-dimethylamino)ethyl methacrylate (PDMAEMA) under stirring for 1 hour. Finally, the functionalized mesh may be obtained by heating under vacuum at 150° C. for about 12 hours to enable quaternization between the iodo functional groups of the attached IPS and the amine group of PDMAEMA. The unreacted polymers were removed by washing them with copious amounts of ethanol. The coated mesh may be subsequently treated with an acidic solution of pH 2 and lower to make the mesh hydrophilic or treated with an alkaline solution of pH 8 and higher to make the mesh oleophilic. Alternatively or in combination, the coated mesh may be kept at a temperature of 25° C. and lower to make the mesh hydrophilic or heated at a temperature of 55° C. and higher to make the mesh oleophilic.

Without being bound by theory, the surface of the mesh contains hydroxyl groups which displace the alkoxy groups of the silane to bond the silane moiety to the mesh. When three alkoxy groups are present, all three may be displaced by the hydroxyl groups, but the displacement of one or two alkoxy groups is also possible.

The surface-grafted OTS may provide low surface-energy chains to give hydrophobicity to the filter under non-acidic conditions. IPS functionalizes the surface of the mesh with iodo-alkyl groups via silanization, and serves as a linker (or binder) for subsequent grafting of pH-responsive materials on its surface. Other suitable leaving groups may be used in place of the iodo group, for example some common leaving groups include triflate, mesylate, tosylate, bromo, and chloro.

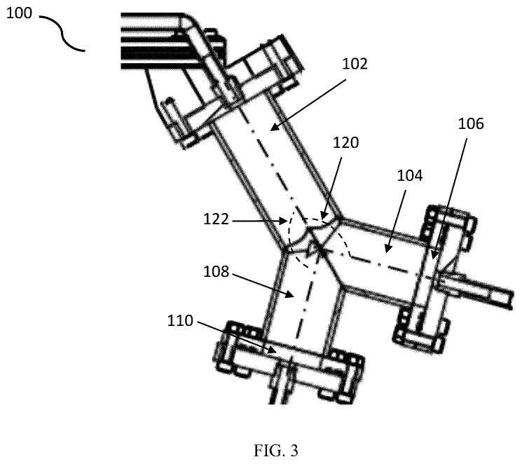

Comparisons between the original surface of a sintered stainless steel and the PDMAEMA-IPS-OTS functionalized surface of a sintered stainless steel seen under the scanning electron microscope (SEM) are shown in FIG. 4(a) and FIG. 4(b), respectively. As seen in FIG. 4(a), the original surface of a sintered stainless-steel mesh has a cross-linked fiber network surface, while the PDMAEMA-IPS-OTS functionalized surface of the mesh is relatively rough with several aggregates clearly visible (see inset of FIG. 4(b), the scale bar in the inset is 10 μm).

The viability of switching between the hydrophilic and oleophilic nature of the filter is determined by the ratio of poly(2-(N,N-dimethylamino)ethyl methacrylate (PDMAEMA) to OTS. Assuming that the OTS and IPS react with the mesh surface in the same ratio, and that all of the attached IPS reacts with PDMAEMA, the molar ratio of PDMAEMA to OTS will be identical or very close to the ratio of IPS to OTS added.

Filters with other mass ratios of IPS to OTS from the range of 7:3 to 3:7 were also prepared as per the example above to prepare the oil-water separation filter, and corresponds to a molar ratio of IPS to OTS from the range of 3:1 to 1:1.8.

The water contact angle (WCA) of the oil-water separation filter at a pH value of no less than 8 increased from 62° to 150° upon increasing the mass ratio of OTS over IPS (from 3/7 to 7/3) and may be due to the increasing number of hydrophobic octadecyl chains on the surface. A filter prepared with an OTS to IPS mass ratio of 7:3 may be more hydrophobic (and ideally more oleophilic) than a filter prepared with a lower OTS to IPS mass ratio.

The surface wettability of the filter could be switched to superhydrophilicity (a WCA of) 0° at a pH of 2 and lower, and may be well maintained until the ratio of IPS to OTS is as low as 3:7. Further increases in the amount of OTS may significantly increase the WCA of the filter, and the surface becomes hydrophobic. This may be because lowering the amount of IPS might cause a significant decrease of grafted PDMAEMA onto the silanized mesh via quaternization, leading to the loss of the superhydrophilicity of the filter at a pH of 2 and lower.

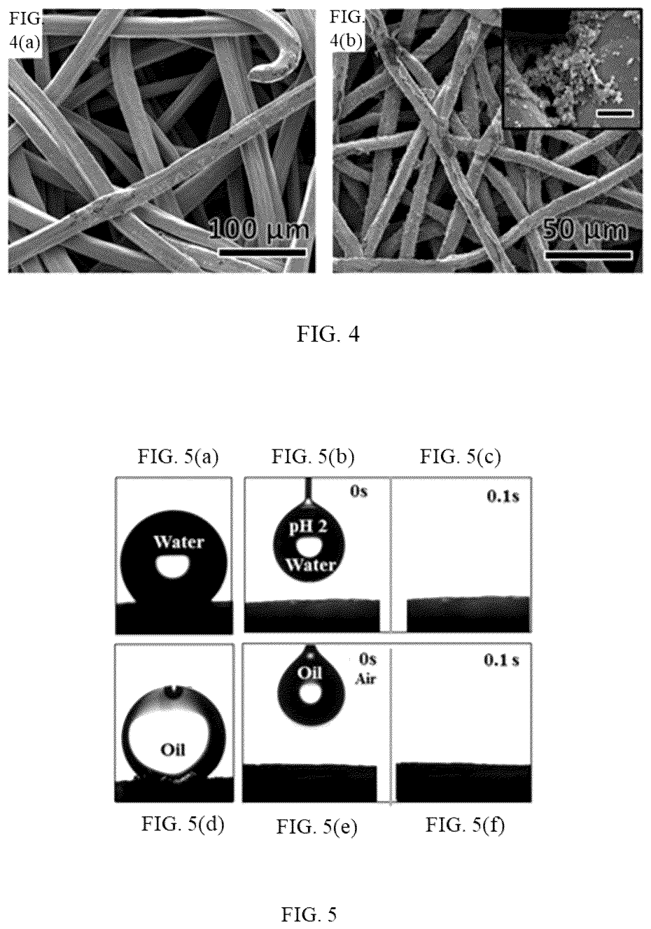

In an example, the WCA on the filter (PDMAEMA-IPS-OTS functionalized sintered stainless steel mesh) without acid treatment in air is shown in FIG. 5(a). The WCA on the surface of the filter is 141±2°, and the surface of the filter is superhydrophobic. Therefore, the water droplets are blocked by the filter, while the oil droplets flow through when the filter is exposed to the air. In contrast, when an acidic water droplet of pH 2 is placed on the filter in the air, it is completely absorbed in 0.1 s, as shown in FIGS. 5(b) and 5(c), which are still images of the acidic water droplets on the surface of the filter captured in video measurements. The surface wettability of the filter may be switched from hydrophobic to hydrophilic by treatment with acid, for example by using acidic water.

When an oil droplet is placed on the filter in the acidic water of pH 2, the underwater oil contact angle is measured to be 150±1°, as shown in FIG. 5(d), indicating the oleophobicity of the surface in acidic water. However, when an oil droplet is placed on the filter in the air (shown in FIG. 5(e)), the oil is completely absorbed into the filter within 0.1 s (shown in FIG. 5(f))), and demonstrates the switchable wettability of the filter in different pH media. The flux and oil rejection of the filter are measured to be 5320±15 LMH and 99±0.3%, respectively. Alternatively, the filter may be switched between oleophilicity and hydrophilicity by heating or cooling the mesh respectively.

(Octadecyl) silane (OTS) as the silane moiety with the hydrophobic alkyl chain in combination with the PDMAEMA pH-responsive homopolymer provide a switchable surface wettability to the coating layer of the mesh allowing it to function as an oil-water filter. OTS is attached (or grafted) directly to the mesh surface and may induce the hydrophobicity/superhydrophobicity of the mesh surface when the pH value is 8 and higher. Some of the amines (in particular tertiary amines) in the side chain of PDMAEMA will be quaternized (formation of quaternary ammonium cations) to graft the PDMAEMA onto the mesh surface, but other (likely most of them) amines still have available lone pairs that may be protonated in acidic conditions. The switchable wettability of the filter may primarily be dependent on the amount of the PDMAEMA and OTS used. When the pH value is 8 and higher, the PDMAEMA is not protonated and exhibits a collapsed conformation. Correspondingly, more hydrophobic OTS chains could dominantly expose themselves to air, which turns the surface of the mesh hydrophobic and retains its high affinity to oil. In contrast, at a pH of 2 and lower, the amine groups of PDMAEMA are protonated. The protonated PDMAEMA chains exhibit an extended conformation because of the electrostatic repulsion among the like charges and tend to stretch from the surface of the mesh, resulting in the formation of hydrophilic layers on the surface. In addition, the hydrophilic layers effectively block the access of oil by the grafted hydrophobic silane moiety, and endows the filter with superior oil-repellence ability at a low pH of 2 and lower. It will be appreciated that the pH value where the filter changes its hydrophilic and oleophilic characteristics depends on the pKa of the basic or acidic moieties involved, and can be readily determined by methods in the art. The filter may also switch between the hydrophilic and oleophilic nature by temperature (heating or cooling). The filter switches from being hydrophilic to oleophilic at 55° C. and from oleophilic to hydrophilic at 25° C. The switching of the filter from oleophilic to hydrophilic and vice versa is generally quick and within about 5 minutes.

Filters with other pH-responsive polymers may be prepared by replacing PDMAEMA with the desired polymer in the example above. The pH and temperature threshold values of these other polymers will differ from the PDMAEMA polymer in the mesh coating.

### Connector and Oil-Water Separation Apparatus

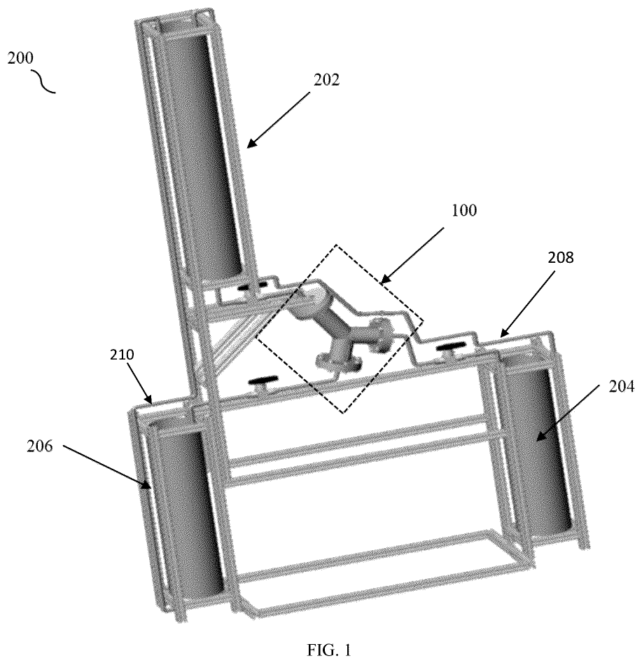

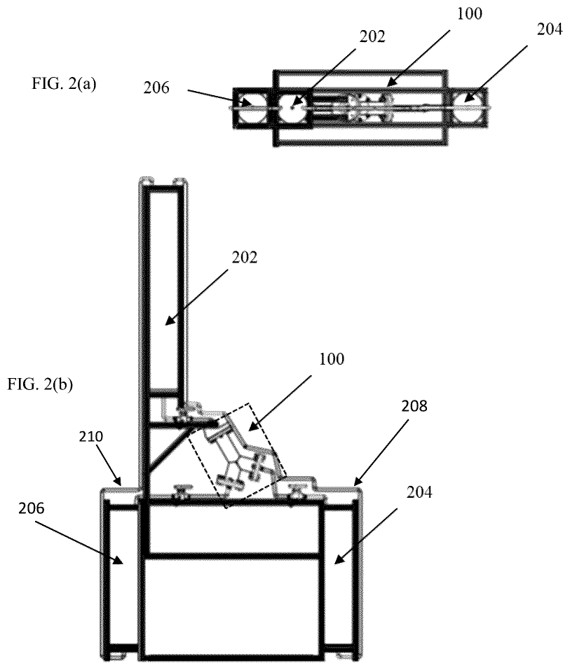

FIG. 1 shows a perspective schematic diagram of an oil-water separation apparatus 200. FIGS. 2a, 2b, and 2c show a schematic diagram of the apparatus 200 from the top, front, and side respectively. In these figures, the oil-water separation apparatus 200 may include a feed tank 202 for holding an oil-water mixture, an oil tank 204 for receiving and holding oil from the connector 100, a water tank 206 for receiving and holding water from the connector 100, and a connector 100.

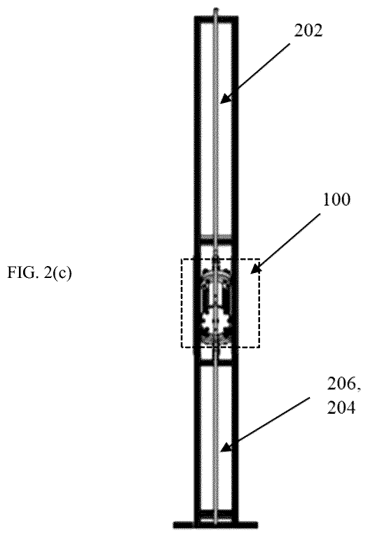

FIG. 3 shows an expanded view of the connector 100 in FIG. 2(b). The connector 100 may include an inlet 102 for receiving an inflow of an oil-water mixture from the feed tank 202, an oil outlet 104 for dispensing an outflow of oil into the oil tank 204, and the first filter 106. The first filter 106 may be arranged proximate to the oil outlet 104 and treated to repel water and allow oil to flow through the first filter 106 to provide the outflow of oil. The first filter 106 may be alkaline treated or temperature treated to make it oleophilic as explained above. The connector 100 may also include a water outlet 108 for dispensing an outflow of water to the water tank 206. The second filter 110 may be arranged proximate to the water outlet 108 and treated to repel oil and allow water to flow through the second filter 110 to provide the outflow of water. The second filter 110 may be acid treated or temperature treated to make it hydrophilic as explained above. Each of the filters 106, 110 may be attached permanently or removably to the connector 100, in particular attached along or in the oil outlet 104 and water outlet 108. For example, for ease of removal the filters 106, 110 may be secured in a filter holder or cartridge and allows for the easy installation and replacement of the filter 106, 110.

The inlet 102 may be fluidly coupled to the feed tank 202, the oil outlet 104 may be fluidly coupled to the oil tank 204, and the water outlet 108 may be fluidly coupled to the water tank 206. The fluid coupling of the connector 100, and tanks 202, 204, 206 may be by any conventional means such as pipes. Pumps, valves, and pressure gauges may be provided as required. A backflow pipe 208, 210 may be provided from each of the oil tank 204 and water tank 206 to the feed tank 202. This may be for recycling the oil and/or water, for a second filtration pass, or other reasons.

As may be seen in FIG. 3, the first filter 106 may be at least partially arranged at a higher elevation relative to the second filter 110 to increase the likelihood of contact of the oil of the oil-water mixture with the first filter 106 when the oil-water mixture flows from the inlet 102 to the oil outlet 104 and the water outlet 108 by the action of gravity. The elevation of the filters 106, 110 is with respect to the flow of the oil-water mixture as shown in FIG. 3, where the oil-water mixture flows downward from the inlet 102 towards the oil outlet 104 and first filter 106, and the water outlet 108 and the second filter 110. The feed tank 202 may be placed higher than the connector 100 as shown in FIGS. 1 and 2(b). The oil-water mixture may need to be pumped into the feed tank 202 or directly into the inlet 102 especially if the feed tank 202 is below the inlet 102.

The connector 100 may allow the oil and the water in the oil-water mixture to be separated continuously. The oil-water mixture may flow into the connector 100 via inlet 102. As the second filter 108 is hydrophilic, the water droplets pass through the second filter 108 and the oil droplets are repelled. Similarly, as the first filter 106 is oleophilic, the first filter 106 allows oil to pass through while repelling water. In FIG. 3, the filters 106, 110 are placed at the end of the oil outlet 104 and water outlet 108 respectively but may be placed anywhere along the respective outlets 104, 108. placing the filters 106, 110 at the end allows for the oil-water mixture to accumulate in the respective outlets 104, 108 and increases the contact time with the filters 106, 110. It will be appreciated that this arrangement of filters 106, 110 are for a mixture where the oil is less dense than water. If the oil is denser than water, the filters 106, 110 may be switched either physically or by changing the characteristic of the filters 106, 110. Alternatively, a second oil may be added to lower the overall (or average) density of the oil component to below that of water.

The connector 100 may be Y-shaped as shown in FIG. 3. In various embodiments, a first angle 120 between an axis of the inlet 102 and an axis of the oil outlet 104 and a second angle 122 between an axis of the inlet 102 and an axis of the water outlet 108 may be each independently be from about 100° to about 170°, preferably from about 120° to about 150°, more preferably from about 130° to about 140°. In various embodiments, an angle between the axis of the oil outlet 104 and a horizontal direction may be from about 10° to about 20°. By having the connector 100 angled as such, it allows the connector 100 to efficiently separate the oil and water in the mixture by gravity. Other shapes and angles of the connector 100 may be used but may be less efficient.

The connector 100 and separation apparatus 200 may be operated in a method of separating an oil-water mixture by feeding the oil-water mixture into the connector 100 via the inlet 102 of the connector 100, contacting the first filter 106 and the second filter 110 of the connector 100 with the oil-water mixture, passing oil through the first filter 106 into the oil tank 204, and passing water through the second filter 110 into the water tank 206.

Thus, it is preferable that contacting the first filter and the second filter of the connector with the oil-water mixture occurs between a first pH threshold value and a second pH threshold value and between a first temperature threshold value and a second temperature threshold value, wherein the first filter and/or second filter becomes hydrophilic at the first pH threshold value and/or the first temperature threshold value, and the first filter and/or second filter becomes oleophilic at the second pH threshold value and/or the second temperature threshold value. Hence, when the pH-responsive polymer is PDMAEMA, the first and second pH threshold values may be 2 and 8 respectively, and the first and second temperature threshold values may be 25° C. and 55° C. respectively.

The connector 100 and oil-water separation apparatus 200 are preferably operated within a pH range and temperature range between the pH and temperature threshold values where the mesh and filters 106, 110 switch between their hydrophilic and oleophilic characters. For example, a filter with the PDMAEMA-IPS-OTS mesh coating may operate between a pH range of 2 to 8 and temperature range of 25° C. to 55° C., excluding the endpoints pH of 2 and 8 and temperatures of 25° C. and 55° C., to get the optimum performance of switchable wettability when using this functionalized mesh, and avoid the filters 106, 110 from switching its hydrophilic or oleophilic character.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims and therefore intended to be embraced.

1. A filter comprising:
a mesh; and
a coating layer on the mesh, the coating layer comprising a first silane moiety and a pH-responsive polymer, wherein the first silane moiety comprises a hydrophobic alkyl chain, the first silane moiety is attached directly to the mesh, and the pH-responsive polymer is attached to the mesh by a linker.

2. The filter as claimed in claim 1, wherein the pH-responsive polymer is a homopolymer of general formula (I), 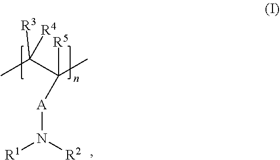
wherein R¹ and R² are each independently selected from methyl, ethyl, propyl, and isopropyl,
wherein R³, R⁴, and R⁵ are each independently selected from hydrogen, methyl, and ethyl,
and wherein A is a linking group selected from the group consisting of an ester, an amide, an ether, a methylene chain, and any combinations thereof,
wherein the pH-responsive polymer is attached to the linker by bonding to at least one amino group in the pH-responsive polymer.

3. The filter as claimed in claim 2, wherein A is of general formula (II), 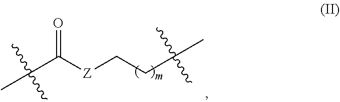
wherein Z is oxygen or NR⁶, R⁶ is hydrogen, methyl, or ethyl, wherein m is 1, 2, 3, or 4.

4. The filter as claimed in claim 3, wherein Z is oxygen and m is 1.

5. The filter as claimed in claim 2, wherein R¹ and R² are methyls, and the pH-responsive polymer is attached to the linker by quaternization of at least one amino group in the pH-responsive polymer.

6. The filter as claimed in claim 2, wherein R³ and R⁴ are hydrogen and R⁵ is methyl.

7. The filter as claimed in claim 2, wherein the pH-responsive polymer is poly(2-(N,N-dimethylamino)ethyl methacrylate.

8. The filter as claimed in claim 1, wherein the hydrophobic alkyl chain of the first silane moiety has at least 13 carbon atoms.

9. The filter as claimed in claim 1, wherein the linker comprises a second silane moiety having an alkyl group and an alkoxy group.

10. The filter as claimed in claim 9, wherein the alkyl group of the second silane moiety has 2 to 6 carbon atoms.

11. The filter as claimed in claim 9, wherein the first silane moiety and/or the second silane moiety are each independently attached to the mesh by 1 to 3 silicon-oxygen bonds.

12. The filter as claimed in claim 1, wherein a molar ratio of the first silane moiety to the linker is from 1:4 to 2:1.

13. The filter as claimed in claim 1, wherein a molar ratio of the first silane moiety to the pH-responsive polymer is from 1:4 to 2:1.

14. The filter as claimed in claim 1, wherein the mesh is made of metal.

15. The filter as claimed in claim 1, wherein the mesh is treated in an acidic solution and/or temperature treated to make the mesh hydrophilic.

16. The filter as claimed in claim 1, wherein the mesh is treated in an alkaline solution and/or temperature treated to make the mesh oleophilic.

17. A method of preparing a filter, the method comprising:
modifying a surface of a mesh with a mixture to provide a modified surface of the mesh, the mixture comprising a first silane moiety and a linker, the first silane moiety comprises a hydrophobic alkyl group and at least one alkoxy group; and
reacting a pH-responsive polymer with the linker on the modified surface to form a coating layer on the mesh.

18. The method as claimed in claim 17, wherein the pH-responsive polymer is a homopolymer of general formula (I), 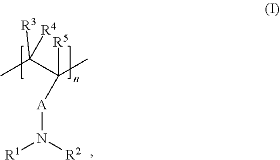
wherein R¹ and R² are each independently selected from methyl, ethyl, propyl, and isopropyl,
wherein R³, R⁴, and R⁵ are each independently selected from hydrogen, methyl, and ethyl,
and wherein A is a linking group selected from the group consisting of an ester, an amide, an ether, a methylene chain, and any combinations thereof.

19. The method as claimed in claim 18, wherein A is of general formula (II), 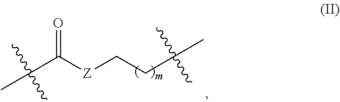
wherein Z is oxygen or NR⁶, R⁶ is hydrogen, methyl, or ethyl, and wherein m is 1, 2, 3, or 4.

20. The method as claimed in claim 19, wherein Z is oxygen and m is 1.

21. The method as claimed in claim 18, wherein at least one of the following conditions is fulfilled:
(i) R¹ and R² are methyls;
(ii) R³ and R⁴ are hydrogen and R⁵ is methyl;
(iii) the hydrophobic alkyl chain of the first silane moiety has at least 13 carbon atoms;
(iv) the linker comprises a second silane moiety having an alkyl group with a leaving group to be substituted with the pH responsive polymer and an alkoxy group; and
(v) the mesh is made of metal.

22. The method as claimed in claim 21, wherein the alkyl group of the second silane moiety has 2 to 6 carbon atoms.

23. The method as claimed in claim 21, wherein the first silane moiety and/or second silane moiety have three alkoxy groups.

24. The method as claimed in claim 17, wherein the pH-responsive polymer is poly(2-(N,N-dimethylamino)ethyl methacrylate.

25. The method as claimed in claim 17, wherein a molar ratio of the first silane moiety to the linker is from 1:4 to 2:1.

26. The method as claimed in claim 17, wherein a molar ratio of the first silane moiety to the pH-responsive polymer is from 1:4 to 2:1.

27. The method as claimed in claim 17, comprising treating the coated mesh with an acidic solution of a first pH threshold value and lower and/or keeping the coated mesh at a first temperature threshold value and lower to make the coated mesh hydrophilic.

28. The method as claimed in claim 17, comprising treating the coated mesh with an alkaline solution of a second pH threshold value and higher and/or heating the coated mesh at a second temperature threshold value and higher to make the coated mesh oleophilic.

29. A filter prepared by the method as claimed in claim 17.

30. A connector for separation of oil and water, the connector comprising
an inlet for receiving an inflow of an oil-water mixture;
an oil outlet for dispensing an outflow of oil;
a first filter as claimed in claim 1, the first filter is arranged proximate to the oil outlet and treated to repel water and allow oil to flow through the first filter to provide the outflow of oil, wherein the first filter is alkaline treated or temperature treated;
a water outlet for dispensing an outflow of water;
a second filter as claimed in claim 1, the second filter is arranged proximate to the water outlet and treated to repel oil and allow water to flow through the second filter to provide the outflow of water, wherein the second filter is acid treated or temperature treated;
wherein the first filter is at least partially arranged at a higher elevation relative to the second filter to increase likelihood of contact of the oil of the oil-water mixture with the first filter when the oil-water mixture flows from the inlet to the oil outlet and the water outlet by the action of gravity.

31. The connector as claimed in claim 30, wherein a first angle between an axis of the inlet and an axis of the oil outlet and a second angle between an axis of the inlet and an axis of the water outlet is each independently from about 100° to about 170.

32. The connector as claimed in claim 31, wherein an angle between the axis of the oil outlet and a horizontal direction is from about 10° to about 20°.

33. An oil-water separation apparatus, comprising
a feed tank for holding an oil-water mixture;
an oil tank for holding oil;
a water tank for holding water; and
the connector as claimed in claim 30, the inlet fluidly coupled to the feed tank, the oil outlet fluidly coupled to the oil tank, and the water outlet fluidly coupled to the water tank.

34. A method of separating an oil-water mixture, the method comprising
feeding the oil-water mixture into the connector as claimed in claim 30 via the inlet of the connector;
contacting the first filter and the second filter of the connector with the oil-water mixture;
passing oil through the first filter and out of the connector via the oil outlet; and
passing water through the second filter and out of the connector via the water outlet.

35. The method as claimed in claim 34, wherein contacting the first filter and the second filter of the connector with the oil-water mixture occurs between a first pH threshold value and a second pH threshold value and between a first temperature threshold value and a second temperature threshold value, wherein the first filter and/or second filter becomes hydrophilic at the first pH threshold value and/or the first temperature threshold value, and the first filter and/or second filter becomes oleophilic at the second pH threshold value and/or the second temperature threshold value.

36. The method as claimed in claim 35, wherein the first pH threshold value is 2, the second pH threshold value is 8, the first temperature threshold value is 25° C., and the second temperature threshold value is 55° C.
